(19) United States
(12) Patent Application Publication
(10) Pub. No.: US 2012/0118420 A1
(43) Pub. Date: May 17, 2012

(54) Device to control the rate of fluid flow in a pipe

(75) Inventors: Richard A. St. Pierre, Horseheads, NY (US); Fletcher W. Chapin, Vestal, NY (US)

(73) Assignee: Richard A. St. Pierre, Horseheads, NY (US)

(21) Appl. No.: 13/373,487

(22) Filed: Nov. 16, 2011

Related U.S. Application Data
(60) Provisional application No. 61/458,005, filed on Nov. 16, 2010.

(51) Int. Cl. F16L 55/027; F15D 1/10; F16L 55/11; G05D 7/00

(52) U.S. Cl. 138/46; 138/40

(57) ABSTRACT

The present invention provides a family of devices insertable into a pipe or pipeline for counteracting the force and controlling the rate of flow of a fluid flowing in the pipe or pipeline. The disclosed devices have an overall shape resembling a spear to improve the fluid dynamic performance and are designed to be self-centering in a pipe. The devices can be made from readily available materials using well known manufacturing techniques. Other embodiments showing extensions to the invention are also disclosed.

### RELATED PATENT APPLICATIONS

This application claims priority to U.S. provisional patent application Ser. No. 61/458,005, filed Nov. 16, 2010, which is hereby incorporated by reference in its entirety.

### FIELD OF THE INVENTION

The present invention relates to counteracting the force of fluid flow in a pipe or pipeline and more particularly, to the controlling and potentially stopping the flow of fluid in said pipeline.

### BACKGROUND OF THE INVENTION

Counteracting the force and rate of fluid flow in pipes or pipelines has many potential applications including but not limited to water, air, natural gas and various forms of oil. Force is an action that changes or tends to change the state of motion of the body upon which it acts. Controlling the rate of flow can sometimes be relatively easy to implement if the control mechanism was properly built into the application and included appropriate redundancy and safety means. But for various reasons including cost, ignorance and greed, a reliable system to counteract the force and rate of fluid flow in a pipe or pipeline and even stop it if necessary has not always been implemented or implemented properly. Implementing a reliable system can be made more difficult for some applications due to the location or working environment. A good example of this is the recent oil spill from the British

Petroleum (BP) Deepwater Horizon (BPDH) drilling rig and associated well in the Gulf of Mexico, a disaster of massive proportion that very likely will affect the environment for decades to come. It took over 100 days to allegedly “kill” the well and to stop the leaking of oil and gas from the array of devices and pipes of varying diameters that make up the well.

The term “pipeline” as used herein is intended to describe a plurality of segments of pipe that may vary in diameter along the length of the pipeline. For example in deepwater oil and gas drilling, it is common practice that the lower pipe segments are of a smaller diameter, (e.g., 7 inches in diameter) than the ones closest to the surface (e.g., 21 inches in diameter). While the pressure of the fluid flowing through both the smaller and larger diameter pipe segments is the same, the force of the fluid in the larger diameter pipe is equal to the pressure times the square of the radius of the pipe. Therefore the force of the fluid in the 21-inch diameter pipe is 9 times greater than in the 7-inch diameter pipe even though the diameter is only three times greater. This is one reason that the 2010 British Petroleum (BP) Deepwater disaster has been so difficult to contain/control due to the high forces of the fluid at the top of the well.

There have been myriad of possible solutions proposed to stop the flow of oil and gas with limited success. Furthermore there are thousands of additional wells that already may or could potentially be leaking gas and oil and need to be dealt with before another ecological disaster occurs.

While it is most desirable to have wells and pipelines implemented with a reliable system to control the flow of fluid in the associated pipes, it would be highly desirable to have a scalable family of devices that can be applied to existing applications as well as new applications that require fluid control.

It would be desirable to insert a device into a smaller diameter pipe, if at all possible in order to reduce the rate of flow of fluid in a pipeline while the fluid is flowing. This may be difficult to accomplish because the device would have to pass through the larger diameter pipes, being subjected to the resistance of the high forces before it could reach the smaller diameter pipe. Therefore it would also be desirable for a device to have an overall shape that would minimize resistance thus optimizing, or at least greatly improving the fluid dynamics of the device to make it easier to install the device in the desired location.

It is therefore an object of the invention to enhance the art of controlling the flow of fluid in a pipe or pipeline.

It is another object of the invention to provide a scalable family of devices to effectively stop or reduce the flow of fluid in a pipe or pipeline even in existing applications where fluid is already flowing.

It is another object of the invention for the family of devices to have an overall shape that would minimize resistance thus optimizing or at least greatly improving the fluid dynamics of the device to make it easier to install the device in the desired location.

### SUMMARY OF THE INVENTION

The present invention provides a family of devices insertable into a pipe or pipeline for altering the rate of flow of the fluid flowing in the pipeline. The disclosed devices have an overall shape resembling a spear to improve the fluid dynamic performance and are designed to be self-centering in a pipe. In a preferred embodiment the device comprises a plurality of prolate spheroid shaped members that help to reduce and, if desired, stop the flow of fluid in the pipe since the spheroids help to counteract the force of the fluid flowing in the pipe. The devices can be made from readily available materials using well known manufacturing techniques. Other embodiments showing extensions to the invention are also disclosed.

### BRIEF DESCRIPTION OF THE DRAWINGS

A complete understanding of the present invention may be obtained by reference to the accompanying drawings, when taken in conjunction with the detailed description thereof and in which:

FIG. 1 is a perspective view of a device to control the rate of flow of fluid in a pipe in accordance with a first embodiment of the present invention shown in FIGS. 1-7;

FIG. 2 is a side view of one of the components of the device shown in FIG. 1;

FIG. 3 is a top view of another of the components of the device shown in FIG. 1;

FIG. 4 is a top view of another of the components of the device shown in FIG. 1;

FIG. 5 is an exploded view of yet more components of the device shown in FIG. 1 emphasizing the relative position of the cam dogs in an open position and prepared for engagement;

FIG. 6 is an exploded view of the components shown in FIG. 5 emphasizing the relative position of the cam dogs in a closed position after engagement to the inner surface of a pipe; and

FIG. 7 is a cross sectional view of the device shown in FIG. 1 emphasizing the relative positioning of the device when inserted into a pipe and near the boundary between pipes of two different diameters.

### DETAILED DESCRIPTION OF THE PREFERRED EMBODIMENT

Generally speaking, the present invention provides a family of devices insertable into a pipe or pipeline for counteracting the force of the fluid flowing in the pipeline.

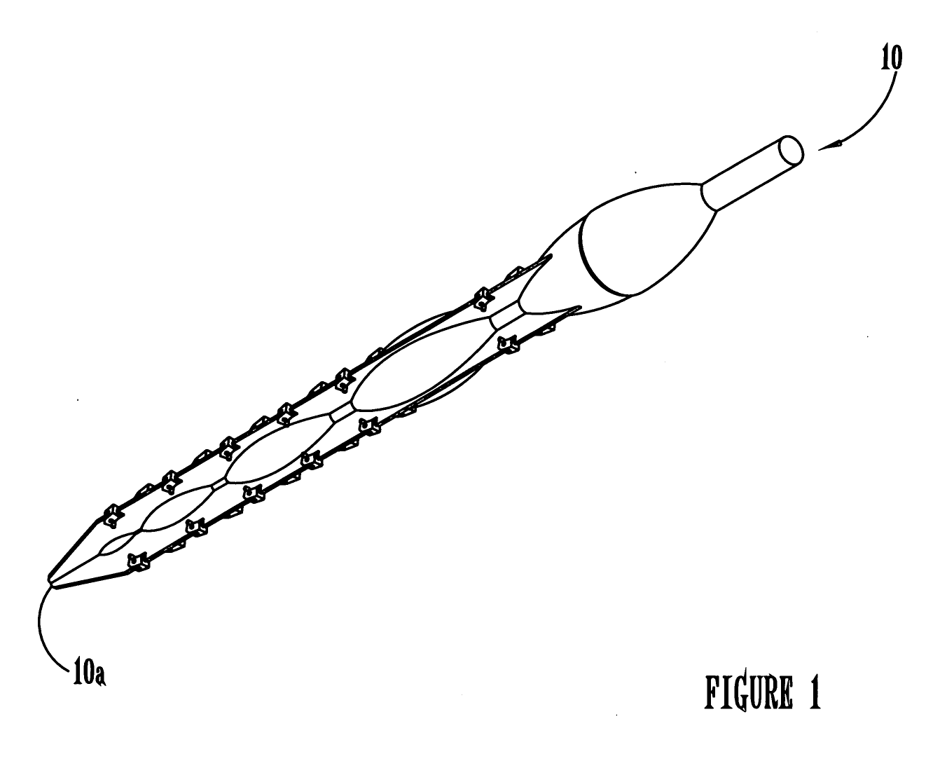

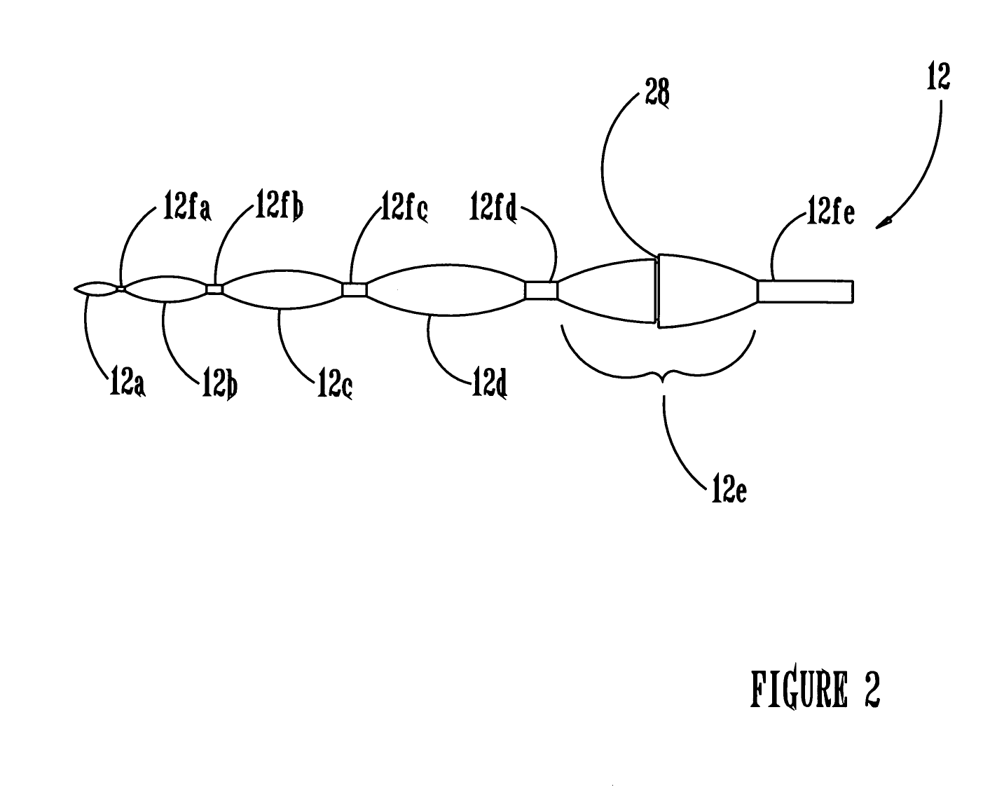

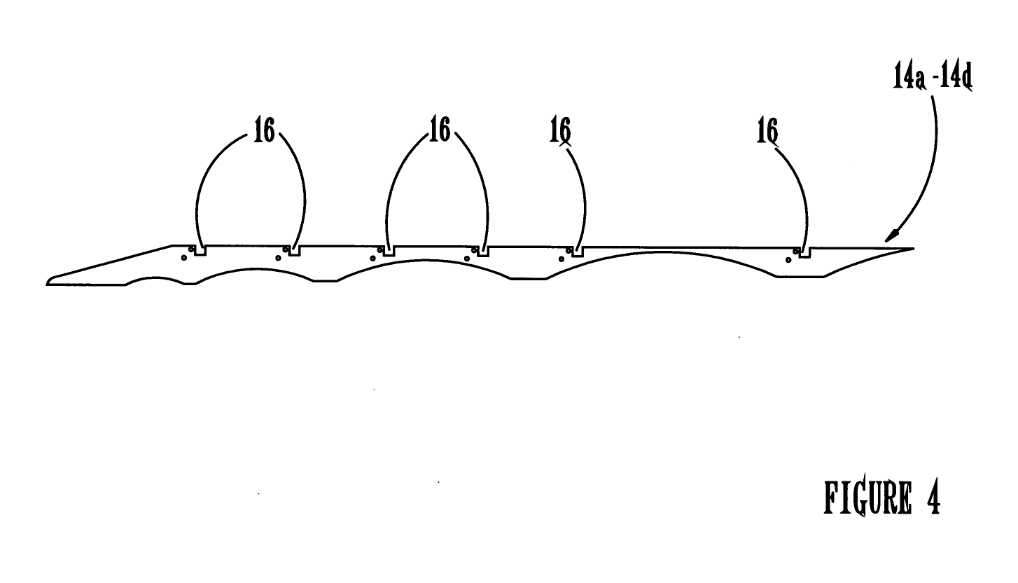

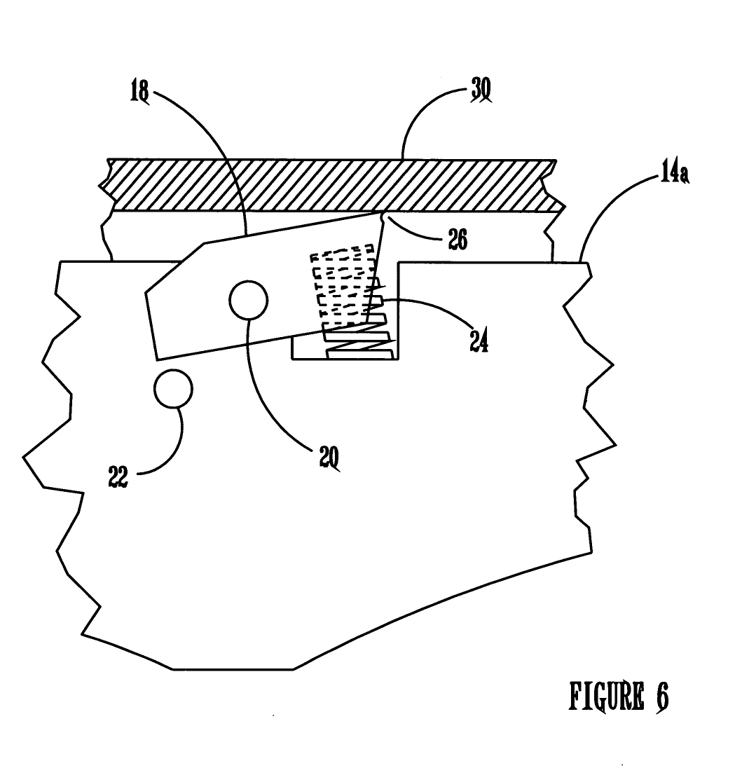

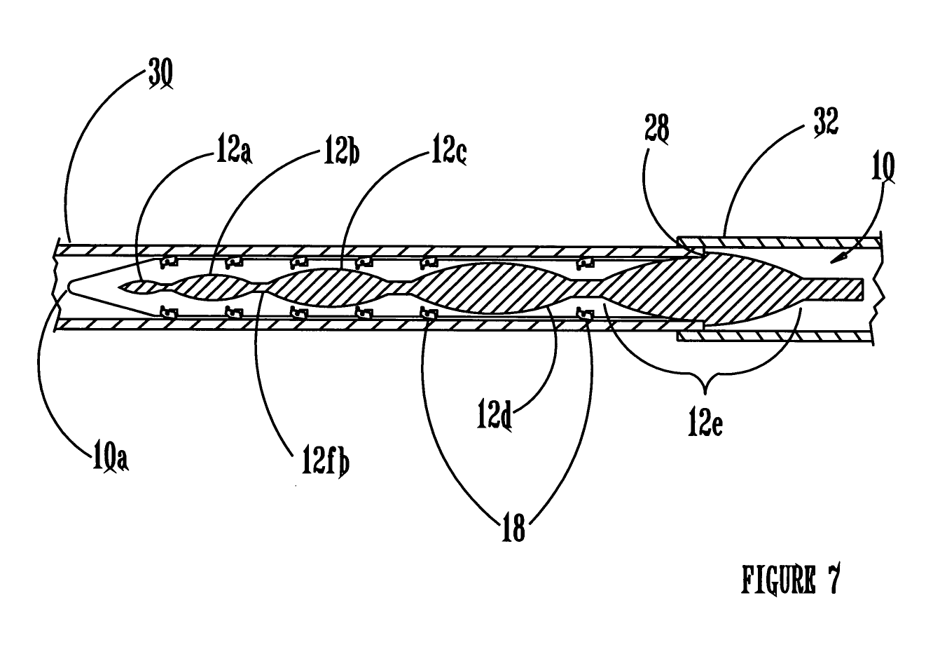

Referring first to FIG. 1, there is shown a perspective view of a device 10 to control the rate of flow of fluid in a pipe 30 (see FIGS. 6 and 7) in accordance with a first embodiment of the present invention. Device 10 (see FIGS. 1-7) comprises components including a center sweep 12, guide fins 14a-14d, and a plurality of cam dogs 18, dowels 20, pins 22, and springs 24. Device 10 has an overall shape resembling a spear to improve its fluid dynamic performance, is about ten feet in length, and weighs about 860 pounds. Device 10 is designed to be self-centering in a pipe. The tip 10a of device 10 will strive to find the point of least resistance in the fluid flowing against it. Therefore tip 10a will try to locate the center of the fluid flow in pipes 30 and 32 (see FIG. 7). It is desirable for device 10 to be long and “sharp” which allows device 10 to penetrate through pipes 30 and 32 further with less opposing resistance although too long a length can be a problem in certain applications described hereinbelow. It is also preferable that the materials used to make device 10 are capable of withstanding the application specific environmental conditions.

Testing of scale models of device 10 has shown that device 10 not only worked well (i.e., to reduce the rate of flow of fluid in a pipeline while the fluid is flowing), but an unexpected benefit was observed: as device 10 moves through pipe 30, and as the largest diameter portion of the largest diameter plug (12e in this embodiment) of device 10 moves very close to the inner wall of pipe 30, instead of the device 10 experiencing more resistance, instead it fortuitously is “sucked” or pulled further into pipe 30 due to the Bernoulli effect (i.e., the Bernoulli principle or Bernoulli's law), which improves the performance of device 10.

In this embodiment center sweep 12 (see FIGS. 1, 2 and 7) comprises five football-shaped plugs 12a-12e connected to one another by rods 12fa-12fe. Plugs 12a-12e and rods 12fa-12fe are preferably made of a very strong material such as steel. Plugs 12a-12e are also similar in shape to a prolate spheroid. Center sweep 12 in this embodiment is axially concentric with respect to a major axis of device 10 and may be made by various processes including but not limited to as a single poured metal part, as a single machined part, or as an assembly of the various components. Rods 12fa-12fe and plugs 12a-12e may even be separable from one another if, for example, they were threaded. This capability would allow one or more of the components to be detachable.

The graduated increase in size of plugs 12a-12e in center sweep 12 is preferred over a continuously variable shape because it allows device 10 the inherent ability to counteract the dynamic force of the fluid in pipe 30 by allowing the flow and pressure of the fluid to slowly decrease in a sequential manner as device 10 is pushed further into pipe 30, thereby reducing the insertion force. Plugs 12a-12e preferably have a smooth exterior to minimize friction thereby increasing the rate of propulsion of device 10.

Referring in particular to FIG. 7, it is important to note that if the maximum diameter of plug 12e is only incrementally larger than the diameter of pipe 30 that it is being inserted into, there may be the possibility of damaging pipe 30 due to the high forces potentially created against the interior surface of pipe 30 and therefore this condition should be avoided. One solution is to make the maximum diameter of plug 12e large enough to literally “seal” pipe 30 with cam dogs 18 holding device 10 within pipe 30. This is, of course, assuming the goal is the total closure of the pipe to seal off the fluid flow and pressure. In this embodiment plug 12e includes an additional design feature, a stop 28, which is implemented as a larger diameter step that cannot fit into pipe 30 and catches on end of pipe 30 rather than on an inner surface. Therefore it is preferable that the maximum diameter of stop 28 is larger than the inside diameter of pipe 30 but no larger than the inside diameter of pipe 32. Stop 28 ensures that while the majority of device 10 will fit within a section of pipe 30 to be plugged, the entire device 10 cannot become a wedge that is potentially capable of splitting pipe 30. Stop 28 would also work similarly even if pipe 32 was not present.

The “seal” can be implemented in many ways such as but not limited to stop 28 disclosed hereinabove; an o-ring; an inflatable bladder; a resilient, compressive layer on plug 12e; or a combination thereof. Once closure of pipe 30 is accomplished, a material such as concrete or other appropriate material(s) could be injected into pipe 30 and 32 or well head to provide an additional level of sealing. Device 10 may be inserted into pipe 30 in various ways including mechanically-assisted means, and gravity-based means such as railroad rails stacked on end, or a “coupled pipe” filled with concrete. Device 10 could even be “fired” into pipe 30 by an appropriate apparatus.

It should be obvious to one skilled in the art that characteristics such as the quantity, individual shape, dimensions, materials, and interconnection of plugs 12a-12e may vary depending on the particular application. For example, although in this embodiment plugs 12a-12e are in increasingly larger size, there may be certain applications where it may be desirable if one or more of plugs 12a-12e might differ in size, shape, quantity or material from the overall sequentially increasing shape as shown in device 10.

There may be applications where pipelines are curved at such a rate that the approximately ten foot long device 10 may not be able to be properly inserted into. This problem may be solved in several ways. One way is to divide device 10 in a series of two or more shorter “sub-devices” that can be individually inserted in increasing sequentially larger size. Another solution is to have plugs 12a-12e interconnected by means functionally similar to a ball joint or the way a universal joint is used to connect a drive shaft and a drive axle in an automobile. Then device 10 would be able to navigate around turns with a much tighter radius. A third solution is to make rods 12fa-12fe from an equally strong but more flexible material. Other solutions to accomplish this same goal should be understood by those skilled in the art.

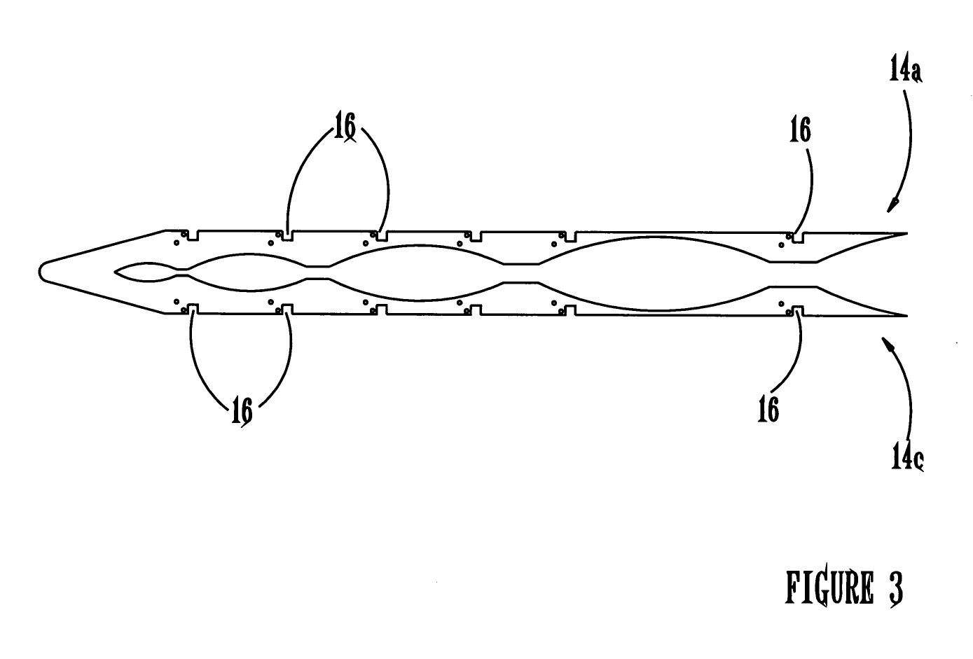

Device 10 comprises four guide fins 14a-14d (see FIGS. 1, 3 and 4) that are preferably made of a material such as steel, mounted 90 degrees apart from one another and are attached to device 10 along the length of each guide fin 14a-14d by a process such as welding. Guide fins 14a-14d are disposed parallel to the major axis of device 10. In this embodiment at least one pair of fins 14a with 14c, or 14b with 14d are made as a pair to simplify construction (see FIG. 3). Each guide fin 14a-14d includes a plurality of openings 16 on the edge outermost from the center of device 10. It should be understood that other materials, quantities, configurations, orientations and attachment processes may be used for fins 14a-14d to accomplish the same or similar functionality, and that modifications may be required to improve device 10 performance for certain applications without departing from the spirit of the invention.

Guide fins 14a-14d (see FIG. 7) preferably have a smooth outer surface to minimize turbulence, and are intended to help device 10 to be self centering once inserted pipe 30 and/or 32, and also to minimize the chances of device 10 inadvertently getting prematurely lodged or “caught” on pipe 30 and/or 32 prior to being inserted far enough to accomplish the desired goal(s).

A plurality of spring activated cam dogs 18 are attached to at least one of guide fins 14a-14d. Cam dogs 18 act as a one way clutch, similar to a ratchet, to allow device 10 to enter pipe 30 (FIGS. 6 and 7) and to lock and lodge to the interior surface of the inner pipe wall while prohibiting device 10 from being ejected by the pressure of the fluid. Each cam dog 18 is retained to one of fins 14a-14d by a corresponding dowel 20, which allows cam dog 18 to rotate around dowel 20. Dowel 20 may be retained in many different ways. The disclosed approach is for dowel 20 to be press fit into guide fin 14a-14d. If dowel 20 had a nail-like head on one end, it could be held in place by a single retaining ring. Another variant of dowel 20 also could be held on each side of guide fin 14a-14d by retaining rings.

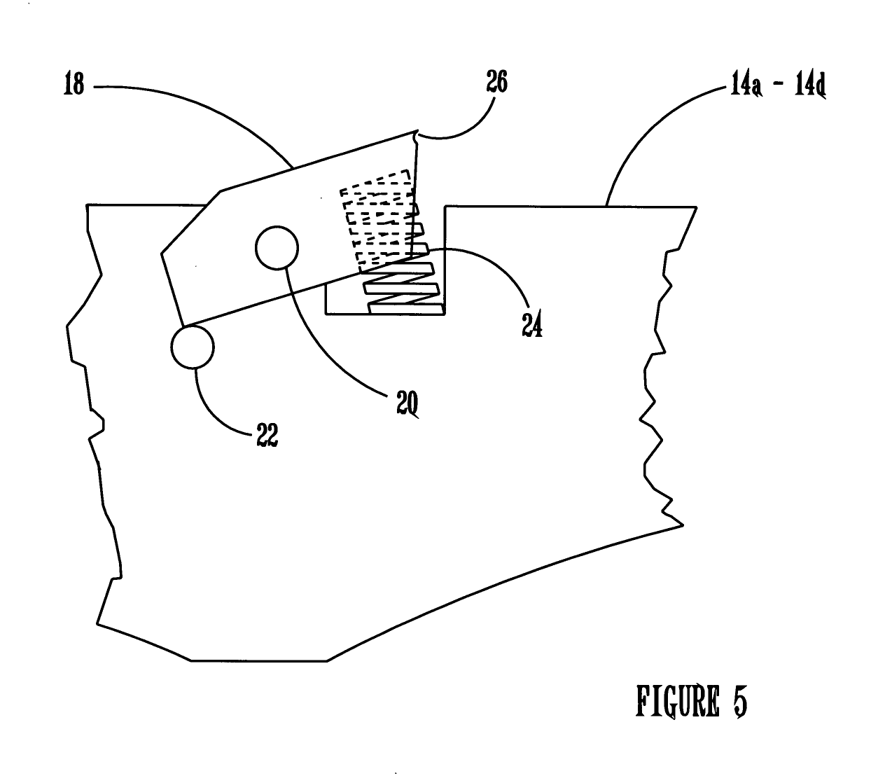

The movement of cam dog 18 is constrained at both ends of travel. When device 10 is in an initial “open cam dog” position (see FIG. 5), the position of cam dog 18 is limited by coming in contact with a corresponding pin 22 in one of guide fins 14a-14d. In this default position, cam dogs 18 extend outward by the force provided by springs 24. Springs 24 are preferably of a die spring type used primarily in die machinery since they are also well-suited for many applications where high-static or shock-load stresses are required, or when maximum cycle-life is important. In this embodiment rectangular wire is employed to reduce the solid height and increase the space efficiency of the design. It should be understood that other types and materials of springs 24 may also be used.

Once open cam dogs 18 begin to come in contact with the inner surface of pipe 30, gripping edge 26, especially at the two outer edges, starts to push against and eventually “dig” or “bite” into the inner surface of pipe 30 forcing spring 24 to compress and cam dog 18 to rotate on dowel 20 and to start retracting into opening 16, whose shape and dimensions limits the extent of travel of cam dog 18 and provides a stop at the other extreme and therefore determines the minimum outer diameter of device 10 when device 10 is in a “closed cam dog” position (see FIGS. 6 and 7). Once the force between corners of gripping edge 26 of cam dog 18 and pipe 30 become high enough as device 10 is attempted to be further inserted into pipe 30, it will be very difficult for device 10 to be easily removed or dislodged from pipe 30, unless the ability to release cam dogs 18 is included in a particular design.

While device 10 was primarily designed to stop the flow of fluid as completely as possible, it should be readily apparent to those skilled in the art that by changing design characteristics such as the diameter of the largest plug 12e and the distance that cam dogs 18 allow between device 10 and the inner diameter of pipe 30 when device 10 is in a “closed cam dog” position, the rate of flow of a fluid can be controlled.

Device 10 could be used to control the rate of flow of fluid in pipe 30 or 32 enough that another valve, for example, a ball valve could be fitted to the end of a properly prepared end of pipe 30 or 32 thereby allowing a more controlled and variable fluid flow.

Various components of device 10 may benefit from having a coating to accomplish different goals or improve performance. For example coating various components such as a plug 12e, even if it did not include stop 28, with a resilient material may provide a superior seal between plug 12e and the interior wall of pipe 30 and even allow the possibility of the entire device 10 being inserted into pipe 30 with a much lower risk of damaging pipe 30.

The inclusion and design of the various components that comprise device 10 are intended to optimize the performance of device 10. While adequate performance may be accomplished with an embodiment that potentially combines the functionality of some of the components (e.g., integrating some form of a fin into, or attaching cam dogs directly to modified plugs), even though the performance of such a device may not necessarily be up to the same level as a design that uses a “divide and conquer” approach to truly optimize the performance of each component and function of a given design, a more integrated type of device could still be useful and cost effective for certain applications and without departing from the spirit of the invention.

Device 10 could be modified to be self-powered, sort of like a torpedo, controlled remotely, and incorporating sensors to monitor quantities such as pressure and flow rate at various positions such as the center and edges of a pipe. The remote control capability could be used to control and direct the positioning of device 10, determine the positioning and actuation of cam dogs 18, send and receive information from the sensors, as well as but not limited to other tasks. The remote capability may be implemented in several ways including permanent wiring, detachable wiring, and wireless communication.

Device 10 could also be modified to incorporate interlocking elements that work in conjunction with mating elements that could be designed into or added onto pipe 30 and/or 32, or a well bore, etc. to offer addition functionality and/or performance improvement. For example, one or more of cam dogs 18 or plugs 12a-12e could be designed and built with interlocking means such as but not limited to threads that would allow device 10 to interlock with mating threads or other design features on the inner surface of a pipe or a well bore. The specific implementation of such features is application dependent.

Device 10 could further be modified to incorporate one or more of plugs 12a-12e, but preferably plug 12e, to be redesigned and built to include a valve (e.g., a ball valve) (not shown) internal to plug 12e, with the valve connected to a plurality of openings (not shown) on the portions of plug 12e located both below and above the “seal” (e.g., see stop 28 in FIG. 7), thereby allowing device 10 the potential to again allow fluid to flow through pipes 30 and 32, but now in a controlled manner and only if desired. The internal valve may be controlled directly, remotely, or even a combination thereof. Again, the specific implementation of this feature is application dependent.

Since other modifications and changes varied to fit particular operating requirements and environments will be apparent to those skilled in the art, this invention is not considered limited to the representative examples chosen for purposes of this disclosure, and covers all changes and modifications which do not constitute departures from the true spirit and scope of this invention.

Having thus described the invention, what is desired to be protected by Letters Patent is presented in the subsequently appended claims.

What is claimed is:

1. A device having an elongated shape and insertable into a pipe or pipeline for altering the rate of flow of a fluid in the pipe or pipeline, the device comprising:
a) a center sweep axially concentric with respect to a major axis of said device, said center sweep comprising at least one prolate spheroid shaped object (PSSO) and at least one rod;
b) a plurality of guide fins attached to said center sweep; and
c) a plurality of cam dogs, attached to selected from the group comprising: at least one of said plurality of guide fins, and said at least one PSSO;
wherein once said device is inserted into said pipe, at least one of said plurality of cam dogs is positioned to contact an inner surface of said pipe and lodge said device in said pipe to alter the rate of flow of the fluid flowing in said pipe.

2. The device as recited in claim 1, wherein said plurality of guide fins are disposed parallel to said major axis.

3. The device as recited in claim 1, wherein said at least one PSSO comprises a plurality of PSSOs, interconnected end to end, one to another, by at least a segment of said at least one rod.

4. The device as recited in claim 3, wherein said plurality of PSSOs are arranged in a primarily overall increasing cross sectional configuration.

5. The device as recited in claim 3, wherein said at least a segment of said at least one rod is selected from the group comprising: a rigid rod, a flexible rod, a rigid rod further comprising interconnection means, and a flexible rod further comprising interconnection means.

6. The device as recited in claim 5, wherein said interconnection means is selected from the group comprising: a ball type joint, and a universal type joint.

7. The device as recited in claim 3, wherein said at least a segment of said at least one rod is selected from the group comprising: a continuous rod, and a separable rod.

8. The device as recited in claim 3, further comprising a seal operably connected to at least one of said plurality of PSSOs.

9. The device as recited in claim 8, wherein said seal is selected from at least one of the group comprising: at least one of said plurality of PSSOs further comprising a stop, an o-ring, an inflatable bladder, and at least one of said plurality of PSSOs further comprising a compressive outer layer.

10. The device as recited in claim 1, further comprising means to remove said device from said pipe.

11. The device as recited in claim 1, further comprising one selected from the group comprising: mechanically-assisted means, gravity-based means, external propulsion means, and self powered means to aid the insertion of said device into said pipe.

12. The device as recited in claim 1, further comprising a valve operably connected to said pipe to provide a more controlled and variable fluid flow through said pipe.

13. The device as recited in claim 1, further comprising sensing means to monitor quantities such as pressure and flow rate at various positions of said pipe.

14. The device as recited in claim 1, further comprising remote control means to monitor and control said device.

15. The device as recited in claim 1, further comprising interlocking means to work with mating interlocking means on said pipe to provide at least one selected from the group comprising: addition functionality and performance improvement.
